(19) United States
(12) Patent Application Publication
(10) Pub. No.: US 2025/0245749 A1
(43) Pub. Date: Jul. 31, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: YUKIO NUMAKAMI, Tokyo (JP); MASAKAZU FUJIKI, Kanagawa (JP)

(21) Appl. No.: 19/010,393

(22) Filed: Jan. 6, 2025

(30) Foreign Application Priority Data
Jan. 30, 2024 (JP) 2024-011711

(51) Int. Cl. G06Q 40/08

(52) U.S. Cl. CPC G06Q 40/08

(57) ABSTRACT

An information processing apparatus configured to determine insurance contents that target damage that could possibly occur during work that is executed by a robot, wherein the information processing system acquires attribute information relating to the robot; acquires work information including information relating to at least one of an environment in which the work will be executed, and work contents for the robot; and determines the insurance contents based on at least one of the work information and the robot attribute information.

### BACKGROUND OF THE INVENTION

### Field of the Invention

The present invention relates to an information processing apparatus, an information processing method, a storage medium, and the like.

### Description of the Related Art

In recent years, robots that are capable of autonomous movement have come to handle various work in the place of humans, and insurance for compensating damages relating to accidents caused by the work that is executed by these robots has been introduced.

For example, Japanese Unexamined Patent Application, First Publication No. 2022-149729 proposes a method in which, in a case in which it is determined whether or not a robot will participate in delivery work, and it is determined that the robot will participate, it is determined that there is a higher risk of an accident occurring than if a human performed the delivery work, and a higher insurance amount is determined.

However, in the method that is disclosed in Japanese Unexamined Patent Application, First Publication No. 2022-149729, there is the problem that the insurance contents cannot be suitably determined according to the work contents that the user would like the robot to execute, and the work environment.

### SUMMARY OF THE INVENTION

In order to achieve the above-described goal, an information processing apparatus according to an embodiment of the present invention is an information processing apparatus configured to determine insurance contents that target damage that could possibly occur during work that is executed by a robot, the information processing apparatus comprising:
one or more memories storing instructions; and
one or more processors executing the instructions to:
acquire robot attribute information relating to the robot;
acquire work information including information relating to at least one of an environment in which the work will be executed, and work contents for the robot; and
determine the insurance contents based on at least one of the work information and the robot attribute information.

Further features of the present invention will become apparent from the following description of embodiments with reference to the attached drawings.

### BRIEF DESCRIPTION OF THE DRAWINGS

FIG. 1 is a diagram showing an example of a usage scene according to the First Embodiment of the present application.

FIG. 2 is a diagram showing a configurational example of an information system comprising the information processing apparatus according to the First Embodiment.

FIG. 3 is a diagram showing a hardware configuration example of the information processing apparatus according to the First Embodiment.

FIG. 4 is a functional block diagram showing a configurational example of an information system comprising the information processing apparatus according to the First Embodiment.

FIG. 5 is a flowchart showing one example of a processing procedure for an information processing method that uses the information processing apparatus according to the First Embodiment.

FIG. 6 is a diagram showing a distribution example for objects in a work environment according to the First Embodiment.

FIG. 7 is a diagram showing an example of risk factor occurrence probability according to the First Embodiment.

FIG. 8 is a diagram showing a display screen example according to the First Embodiment.

FIG. 9 is a functional block diagram showing a configurational example of an information system comprising the information processing apparatus according to the Second Embodiment.

FIG. 10 is a flowchart showing an example of a processing procedure for an information processing method that uses the information processing apparatus according to the Second Embodiment.

FIG. 11 is a diagram showing an example of a display screen according to the Second Embodiment.

FIG. 12 is a functional block diagram showing a configurational example of an information system comprising an information processing apparatus according to a Third Embodiment.

FIG. 13 is a flowchart showing an example of a processing procedure for an information processing method that uses the information processing apparatus according to the Third Embodiment.

FIG. 14 is a diagram showing an example of a display screen according to the Third Embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate descriptions will be omitted or simplified.

### First Embodiment

In the First Embodiment, an example will be explained of an information processing apparatus for a case in which a user of a robot (referred to below as the user) uses a cleaning robot that performs floor cleaning work in a living space.

In addition, an explanation will be given of an information processing method in which suitable insurance contents are determined for the user in relation to a risk of the cleaning robot colliding with an object that exists in the living space. However, the robot in the present invention is not limited to a cleaning robot, and may also be a robot that performs any kind of work. In addition, the invention of the present application can also be applied to a movable apparatus such as a drone, a vehicle, and the like that is capable of autonomous drive, instead of a robot.

In the present embodiment, a provider of the robot (referred to below as the provider) loans the cleaning robot to the user as a rental or provides it as a service, and the price thereof is paid as a usage fee for the robot by the user to the provider.

Furthermore, in preparation for damages in a case in which an accident occurs due to the work that is executed by the robot, the provider or an insurance company provides damage insurance to the user. In a case in which the user opts in to the insurance, the user pays an insurance fee to the provider or the insurance company.

In the present embodiment, before starting the work that will be executed by the robot, the user uses an information terminal that is provided with a camera and measures the living space of the user that will become the work environment for the robot, then transmits the information that has been measured to an information processing apparatus that is operated by the provider or the insurance company.

The information processing apparatus according to the present embodiment is able to determine more appropriate insurance contents for the user by determining the insurance contents based on information relating to the state of the work environment in which the robot will actually execute the work, and information related to the body of the robot.

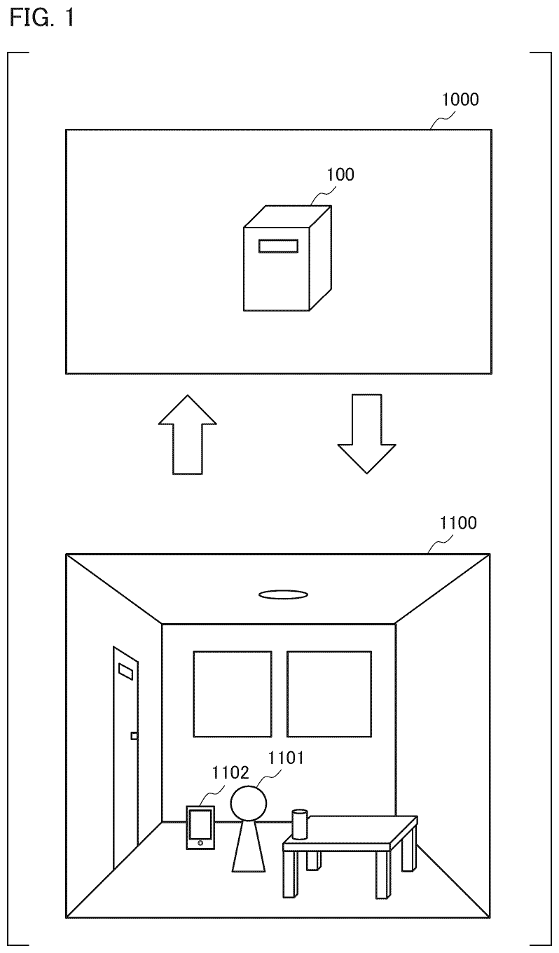

FIG. 1 is a diagram showing an example of a usage scene according to the First Embodiment of the present invention. A data center 1000 is a data center in which an information system 100 that is provided with the information processing apparatus according to the present embodiment is disposed.

The information system 100 is an information system that has been provided with an information processing apparatus 110 according to the present embodiment, and is, for example, a server, and a PC. The information system 100 is able to communicate with an information terminal 1102 that belongs to a user 1101. In the present embodiment, the information system 100 is operated by the provider of the robot or the insurance company.

A work environment 1100 is the work environment for the robot according to the present embodiment. The work environment is a region in which the robot executes work, and in which it is possible for the robot to move in and out of in order to execute the work. The work environment is also referred to as a work region. In the present embodiment, the work environment 1100 is made the living space of the user 1101, who is the user of the robot.

As was explained above, the information terminal 1102 is an information terminal that belongs to the user 1101, and is, for example, a smartphone, or a PC. The information terminal 1102 communicates with the information system 100, and the user 1101 operates the information terminal 1102 and thereby performs the usage procedures and the insurance enrollment procedures for the robot. In addition, the information terminal 1102 is provided with a camera or is connected to a camera.

In the present embodiment, before beginning the work that will be executed by the robot, the user 1101 measures the space for the work environment 1100 using the camera of the information terminal 1102 that belongs to the user 1101, and transmits the measured information to the information system 100 to serve as work information relating to the work environment 1100.

The information system 100 according to the present embodiment determines the insurance contents based on the work information relating to the work environment 1110 that has been transmitted, and information relating to the body of the robot, transmits the insurance contents that have been determined to the information terminal 1102, and provides the insurance contents to the user 1101.

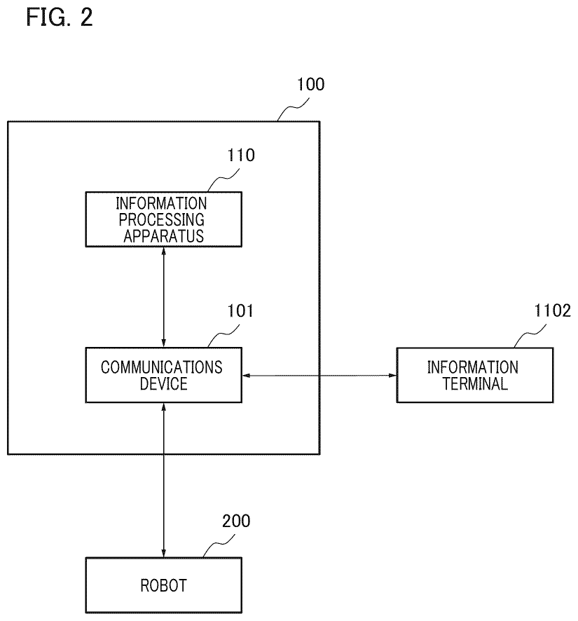

FIG. 2 is a diagram showing a configurational example of an information system that is provided with the information processing apparatus according to the First Embodiment. The information system 100 has a communications device 101, and an information processing apparatus 110. The communications device 101 is provided with a communications function, communicates with the robot 200 and the information terminal 1102, and sends and receives information between these and the information processing apparatus 110.

The information processing apparatus 110 acquires work information relating to the work environment 1100 of the robot, and information relating to the body of the robot from the robot 200 and the information terminal 1102 via the communications device 101, and determines the insurance contents based on this information. That is, the information processing apparatus 110 determines the contents of the insurance that targets damages that could possibly occur during the execution of work by the robot.

In addition, the information processing apparatus 110 transmits the insurance contents that have been determined to the information terminal 1102 via the communications device 101. The robot 200 is the robot according to the present embodiment, and executes work that has been requested by the user 1101 in the work environment 1100 of the user 1101.

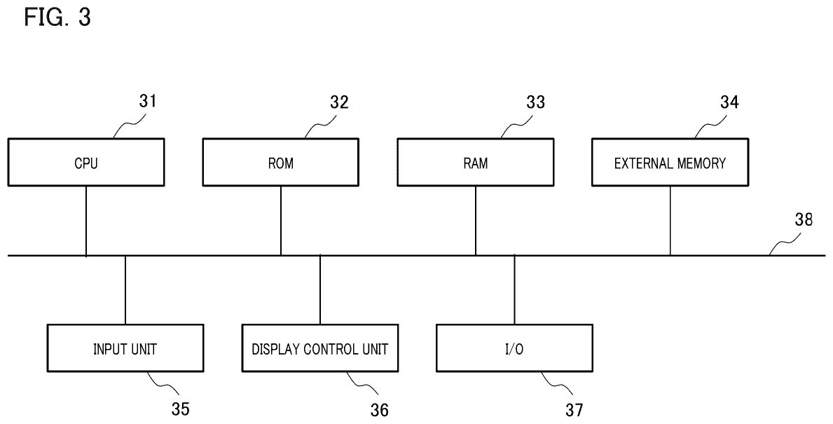

FIG. 3 is a diagram showing a hardware configuration example of the information processing apparatus according to the First Embodiment. A reference numeral 31 is a CPU that serves as a computer, and executes each type of processing according to the present embodiment along with performing control of each device that has been connected to a system bus 38. A reference numeral 32 is a ROM, and stores a BIOS program, and a boot program.

A reference numeral 33 is a RAM and is used as the primary storage device for the reference numeral 31, which is the CPU. The reference numeral 34 is an external memory, and stores programs that are operated by the information processing apparatus 110. An input unit 35 is a keyboard and mouse, and a robot controller, and performs processing according to the input of information and the like.

A display control unit 36 outputs the calculation results from the information processing apparatus 110 to the display device according to a command from the CPU 31. Note that the display device may be a liquid crystal display device and a projector, an LED indictor and the like, and there are no limitations on the type of display device that is used. Note that the display device may be provided on the information processing apparatus, or it may also be provided on the information terminal 1102, which is external to the information processing apparatus. A reference number 37 is an I/O (input/output interface).

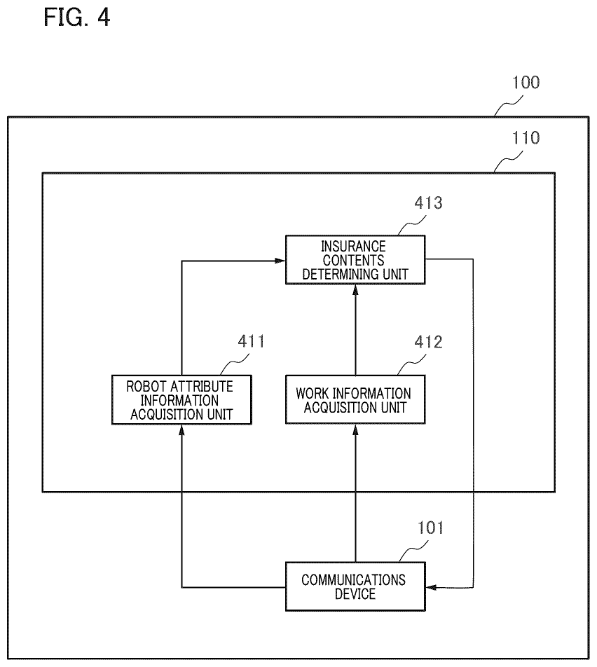

FIG. 4 is a functional block diagram showing a configurational example of an information system comprising the information processing apparatus according to the First Embodiment. Note that a portion of the functional blocks that are shown in FIG. 4 are realized by the CPU 31 that serves as a computer inside of the information processing apparatus executing a computer program that has been stored on a memory that serves as a storage device.

However, it may also be made such that a portion or the entirety thereof is executed using hardware. An application-specific integrated circuit (ASIC), a processor (a reconfigurable processor, a DSP), and the like can be used as this hardware.

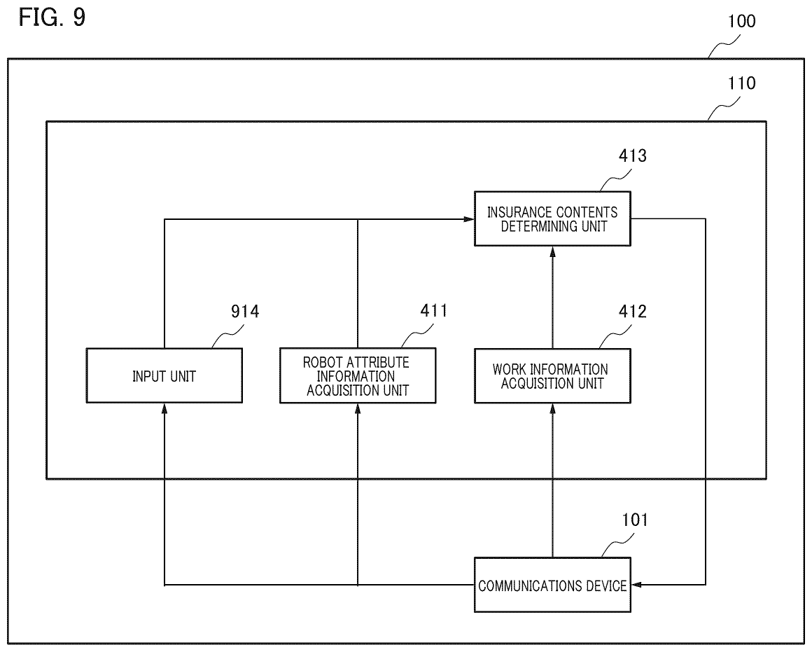

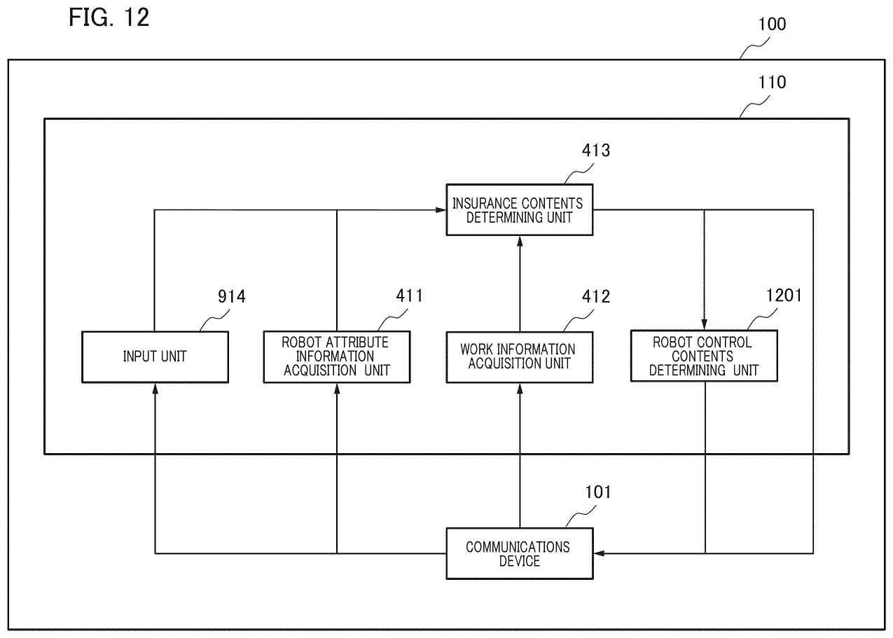

In addition, each of the functional blocks that are shown in FIG. 4 may be housed in the same body, or they may also be configured by separate devices that have been connected to each other via signal paths. Note that the above explanation with respect to FIG. 1 also applies to FIG. 9 and FIG. 12 in the same manner.

The information processing apparatus 110 has a robot attribute information acquisition unit 411, a work information acquisition unit 412, and an insurance contents determining unit 413. The robot attribute information acquisition unit 411 acquires robot attribute information via the communications device 101. The robot attribute information acquisition unit 411 functions as a robot attribute information acquisition means that is configured to acquire robot acquisition information relating to a robot. A detailed explanation of the robot attribute information will be given below.

The work information acquisition unit 412 acquires work information via the communications device 101. The work information acquisition unit 412 functions as a work information acquisition means configured to acquire work information including information relating to at least one of an environment in which the work is executed and the work contents for the robot.

A detailed explanation of the work information will be given below. The insurance contents determining unit 413 functions as an insurance contents determining means, and determines the insurance contents based on a least one of robot attribute information and work information. In addition, the insurance contents determining unit 413 transmits the insurance contents that have been determined to the information terminal 1102 via the communications device 101.

The robot attribute information according to the present embodiment includes information relating to the size of the body of the robot (depth, width, and height), and the safety performance of the robot, and the like. Specifically, as the safety performance of the robot, the braking performance (a distance from when the brake is applied until a complete stop), the obstacle detection performance (detection distance, detection range, detection precision, resolution), and the like of the robot are included.

That is, this information is information relating to the risk of an accident occurring in which the robot collides with a surrounding object. In the present embodiment, the robot attribute information is configured as a set of elements that have been configured in the format of item names and values for Key-Values.

The work information according to the present embodiment is information relating to the work environment 1100. The information relating to the work environment 1100 in the present embodiment includes information relating to objects that exist in the work environment 1100, and includes information relating to the risk of damage, in particular for when the robot has collided with an object. Specifically, this includes information that is related to a shape and a position of each object that exists in the work environment 1100, and is used in order to calculate the ease of collision between the robot and the objects (the probability of a collision occurring).

In addition, the work information includes information relating to the materials of objects that exist in the work environment 1100, and is used in order to calculate how easy it would be to break or damage these objects at the time of collision (the fragility of an object). In the present embodiment, the work information is configured as a set of elements that have been configured in the format of item names and values for Key-Values.

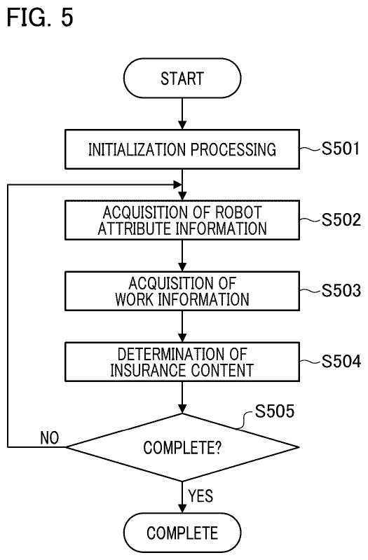

FIG. 5 is a flowchart showing an example of processing procedures for an information processing method that uses the information processing apparatus according to the First Embodiment, and shows an information processing method that determines the contents of insurance that targets damage that could possibly occur during work that is executed by the robot. Note that the processes for each step of the flowchart in FIG. 5 are performed in order by the CPU 31 that serves as a computer inside of the information processing apparatus executing a computer program that has been stored on the memory.

During step S501, the initialization processing for the information processing apparatus 110 is performed. Specifically, the CPU 31 reads an insurance contents determining table. The insurance contents determining table lists a plurality of groups of each item name for the risk of accident, a calculation method (parameters, calculation formula), and corresponding insurance contents (insurance type, and insurance cost) that are all used during the determination of the insurance contents by the insurance contents determining unit 413.

During Step S502, the CPU 31 uses the robot attribute information acquisition unit 411 to acquire the robot attribute information from the robot 200 or the information terminal 1102 via the communications device 101.

In this context, step S502 functions as a robot attribute information acquisition step configured to acquire robot attribute information relating to the robot. During step S503, the CPU 31 uses the work information acquisition unit 412 to acquire work information from the robot 200 and the information terminal 1102 via the communications device 101.

In this context, step S503 functions as a work information acquisition step configured to acquire work information comprising information relating to at least one of an environment in which work is executed or the contents of the work to be executed by the robot.

During step S504, the CPU 31 uses the insurance contents determining unit 413 to determine the insurance contents for the work for the work to be executed by the robot 200 according to the work environment 1100 based on the robot attribute information and work information that have been acquired.

In this context, step S504 functions as an insurance contents determining step configured to determine contents of the insurance based on at least one of the work information or the robot attribute information. The determination method for the insurance contents according to the insurance contents determining unit 413 will be described below. In addition, the insurance contents determining unit 413 transmits the insurance contents that have been determined to the information terminal 1102 via the communications device 101.

During step S505, the CPU 31 determines whether or not the entirety of the processing for the information processing apparatus 110 has been completed. Specifically, in a case in which the robot 200 has completed the work in the work environment 1100, the processing is completed. If this is not the case, the processing returns to step S502, and continues.

During Step S504, the CPU 31 uses the insurance contents determining unit 413 to determine the insurance contents based on the information that shows the safety performance of the robot 200 and the information relating to the work environment 1100 that the user 1101 has measured using the information terminal 1102. At this time, the risk of damage due to the robot 200 colliding with each object that exists in the work environment 1100 is calculated

First, the insurance contents determining unit 413 calculates the distribution of the objects in the work environment 1100 from the information relating to the shapes and the positions of each object that exists in the work environment 1100. In addition, the insurance contents determining unit 413 searches for sets of closest objects that exist in the work environment 1100, and calculates the distance between these closest objects. Note that the distribution of objects according to the present embodiment is calculated as a two-dimensional plane. After this, pre-determined processing is executed for each set of closest objects.

That is, the insurance contents determining unit 413 uses the size (depth and width) of the body of the robot that serves as robot attribute information relating to the robot 200, and subtracts the size of the body of the robot from the distance between a set of closest objects, and multiplies this by 0.5. The distance between the robot 200 and an object in between a set of closest objects in the work environment 1100 is thereby calculated.

Next, the insurance contents determining unit 413 acquires a calculation formula that has been disclosed in a group relating to the collision risk by referring to the insurance contents determining table. In addition, the insurance contents calculating unit 413 calculates the probability of a collision occurring between the robot 200 and an object based on the information relating to the braking performance of the robot 200, and the distance between the robot 200 and the object that occurs between a set of closest objects.

The probability of a collision occurring is calculated such that the closer the distance between an object and the robot 200 becomes, the higher the probability of a collision occurring becomes (greatest value 1), and the farther away the distance between an object and the robot 200 becomes, the smaller the probability of a collision occurring becomes, such that the value asymptotically becomes 0. In addition, the probability of a collision occurring is calculated such that in a case in which the distance between the robot 200 and an object is closer than the distance taken for the robot 200 to come to a complete stop based on the braking performance for the robot 200, the probability of a collision occurring becomes 1. Note that in the present embodiment, the travel speed of the robot 200 is calculated as a default value.

Next, the insurance contents determining unit 413 determines a degree of damage for the event in which the robot 200 has collided with an object based on the information relating to the materials of the objects that exist in the work environment 1100. The degree of damage according to the present embodiment is calculated based on the strength of the material of an object, and in the case that the material of an object is glass or ceramic, the degree of damage is made high, and in a case in which the material of an object is plastic or metal, the degree of damage is made low.

Next, the insurance contents determining unit 413 multiplies the probability of a collision occurring between the robot 200 and an object between a set of closest objects by the degree of damage in the event that the robot 200 collides with an object and calculates the degree of damage for each set of closest objects. This is the processing that is executed for each set of closest objects.

In addition, the insurance contents determining unit 413 calculates a total degree of damage based on a sum total of all of the degrees of damage for the sets of closest objects that have been calculated, and determines the type of insurance and the insurance cost according to the total degree of damage. In the present embodiment, the insurance contents determining unit 413 makes the insurance cost high for the insurance in a case in which the total degree of damage is large, and makes the insurance cost low for the insurance in a case in which the total damage is small.

That is, the insurance contents determining unit 413 calculates a degree of damage that shows the size of the damage that could possibly occur when the robot executes the work based on the work information and the robot attribute information, and determines the contents of the insurance such that the higher the calculated degree of damage becomes, the higher the insurance cost becomes.

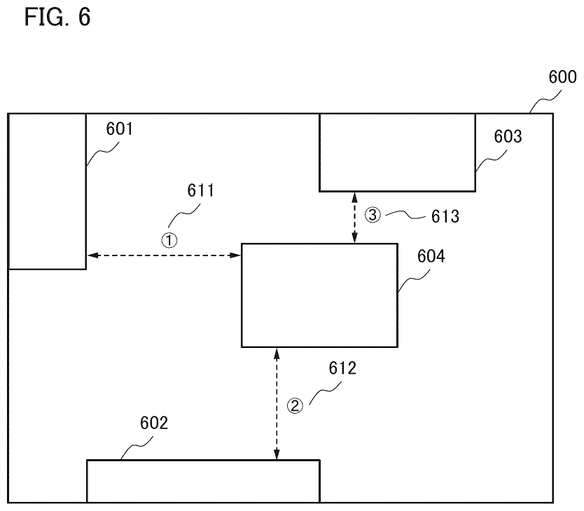

FIG. 6 is a diagram showing a distribution example for objects in the work environment according to the First Embodiment. The distribution of objects in the work environment 1100 according to the present embodiment is calculated by the insurance contents determining unit 413 from the information relating to the shape and the position for each object that exists in the work environment 1100.

A reference numeral 600 shows a distribution of objects in the work environment 1100. Reference numerals 601 to 604 show each object in the work environment 1100. The reference numeral 611 shows the distance between an object 601, and an object 604, which is the closest object thereto. A reference numeral 612 shows a distance between an object 602 and an object 604, which is the closest object thereto. A reference numeral 613 shows a distance between an object 603 and an object 604, which is the closest object thereto.

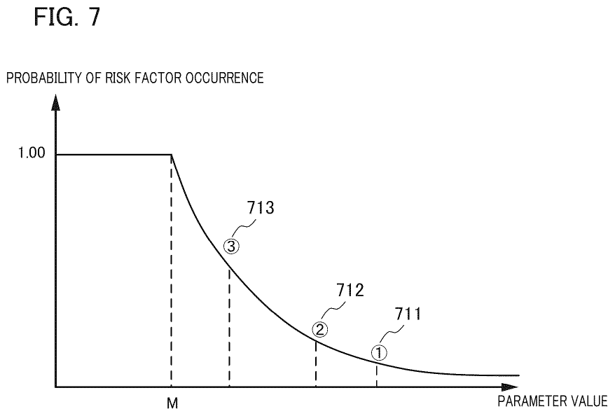

FIG. 7 is a diagram showing an example of a risk factor occurrence probability according to the First Embodiment. The risk factor occurrence probability according to the present embodiment is the probability of a collision occurring between the robot 200 and each object in the work environment 1100, and the vertical axis shows the risk factor occurrence probability. The risk factor occurrence probability according to the present embodiment shows the probability of a collision occurring between the robot 200 and each object.

The horizontal axis represents a parameter value relating to a risk factor. The parameter value relating to a risk factor in the present embodiment shows the distance between the robot 200 and an object. M is a parameter value in which the risk factor occurrence probability becomes 1, and shows a margin relating to the risk factor occurrence probability.

A reference numeral 711 shows the collision occurrence probability at the distance 611 between the object 601 and the object 604 that were shown in FIG. 6. A reference numeral 712 shows the collision occurrence probability at the distance 612 between the object 602 and the object 604 that were shown in FIG. 6. A reference numeral 713 shows the probability of collision occurrence at the distance 613 between the object 604 and the object 604 that were shown in FIG. 6.

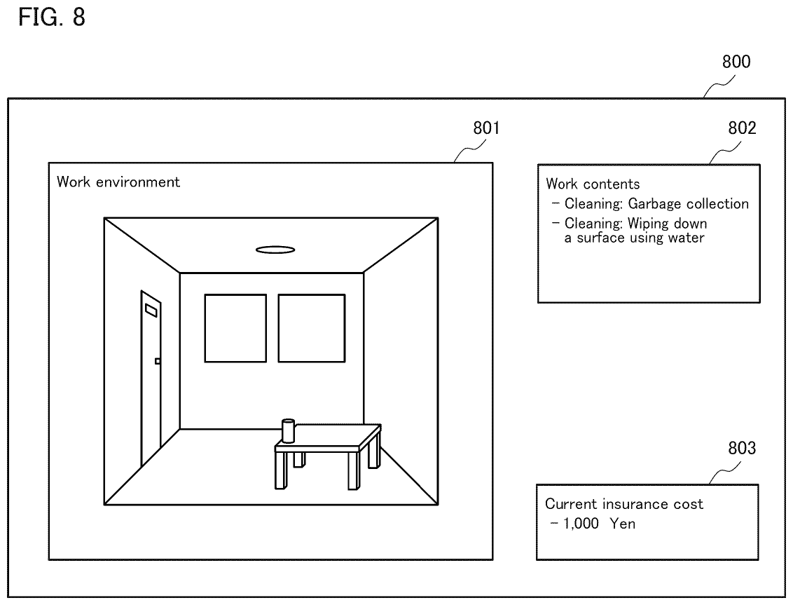

FIG. 8 is a diagram showing an example of a display screen according to the First Embodiment, and shows an example of a screen that is displayed on the information terminal 1102 of the user. A reference numeral 800 is a display screen of the information terminal 1102. A reference numeral 801 is an image that was captured of the work environment 1100 in which the robot 200 will perform work, and if this an image that was captured before the robot 200 began the work, this is an image that was captured using the camera of the information terminal 1102.

In addition, if this image was captured while the robot 200 was executing the work, the reference numeral 801 is an image that was captured by the camera of the robot 200. A reference numeral 802 is a message that shows the work contents of the robot 200. A reference numeral 803 is a message that shows the insurance contents that have been determined by the insurance contents determining unit 413.

According to the method of the present embodiment, it is possible for the information processing apparatus 110 to determine the insurance contents based on information relating to the state of the work environment 1100 of the user and information relating to the body of the robot, and it is possible to provide the user with more appropriate insurance.

Note that although the robot attribute information according to the present embodiment has been made information relating to the size and safety performance of the robot, it is not limited thereto, and it is sufficient if this is any kind of information relating to the risk of collision between the robot and a surrounding object. For example, the robot attribute information may also be visual information relating to a protruding shape of the robot, and the like.

It is thereby possible to more accurately calculate the distance between the robot and an object. If, in a case in which the shape of the robot has a protruding shape such as a human shape, an arm, and the like, the insurance contents calculating unit 413 will determine that when the distance between the robot and an object becomes closer, the probability of collision with surrounding objects becomes high, and will accordingly raise the insurance cost.

In addition, the robot attribute information may also be information relating to the weight of the robot. It is thereby possible to more accurately calculate the degree of damage in the event that the robot collides with an object. The insurance contents determining unit 413 determines that the heavier the weight of the robot 200 becomes, the higher the degree of damage will be in the event that the robot 200 collides with an object, and raises the insurance cost.

In addition, as the safety performance, the robot attribute information may also be information relating to equipment such as a contact detecting function, an emergency brake button, a drive recorder, and the like, or information relating to the safety standards for the robot such as JIS8463, and the like.

It is thereby possible to determine more appropriate insurance contents in relation to the risk of an accident for the robot. That is, in a case in which the robot 200 conforms to safety standards for robots, the insurance contents determining unit 413 will determine that the probability of a collision occurring between the robot 200 and an object becomes lower, and will accordingly lower the insurance cost.

In addition, the robot attribute information may also be information relating to the operating performance of the robot. Specifically, the operating performance of the robot 200 is the travel speed, travel precision, and braking precision of the robot 200. At this time, the insurance contents determining unit 413 calculates the probability of a collision occurring between the robot 200 and an object based on information relating to the travel speed, the travel precision, and the braking precision of the robot 200, and the distance in between the robot 200 and an object in between a set of closest objects.

For example, the insurance contents determining unit 413 performs calculations such that the faster the travel speed of the robot 200 is, or the lower the travel precision of the robot 200 is, or the lower the braking precision of the robot 200 is, the higher the probability of a collision occurring between the robot 200 and an object will become.

In addition, in the case of a robot having a protruding shape such as an arm and the like, the robot attribute information may also be an arm precision that serves as an operation performance, a collision force showing the size of the impact at the time of a collision with the arm serving as the safety performance, a degree of freedom that shows the dexterity of the arm when the arm is holding an object, or a number of joints. It is thereby possible to more appropriately set the insurance contents in relation to a robot that is provided with an arm.

The insurance contents determining unit 413 determines that the impact is small in relation to how small the collision force of the arm is when the arm of the robot has collided with an object, and lowers the insurance cost. In contrast, the larger the degree of freedom for the arm, or the larger the number of joints is, the insurance contents determining unit 413 determines that when the robot 200 is holding an object, it would be difficult for the robot 200 to drop the object, and accordingly lowers the insurance cost.

Note that although the work information in the present embodiment was made information relating to the shape and the position of an object, and information relating to the material of an object to serve as information relating to the objects that exist in the work environment 1100, it is not limited thereto, and it is sufficient if the work information is information relating to the risk of damage occurring due to the work that the robot executes.

For example, the work information may also include information relating to the number and concentration of objects that exist in the work environment 1100. It is thereby possible to more easily calculate the probability of a collision occurring between the robot and a surrounding object. For example, in a case in which the number of objects is large or the concentration of the objects is high, the insurance contents determining unit 413 determines that the probability of a collision occurring between the robot 200 and an object is high, and accordingly raises the insurance cost.

That is, the insurance contents determining unit 413 calculates the probability of the damage that could occur during the work executed by the robot occurring, and determines the contents of the insurance such that the higher the calculated probability of occurrence becomes, the higher the insurance cost for the insurance becomes based on the work information and the robot attribute information.

In addition, the work information may also be information relating to the positional relationships between objects that exist in the work environment 1100, or information relating to the relationship between an object and another object in the work environment 1100. The higher that the risk of a collision with another object occurring becomes due to movements of an approaching object such as travelling, shaking, falling over and the like, the more the insurance cost increases.

In addition, in a case in which an object has been placed on top of another object, the probability of this object falling over due to a movement of the object that is underneath it is calculated, and the insurance cost is raised proportionately as the probability of this object falling increases. Specifically, this is a case in which the object on top has been placed on the edge of the object that is underneath it, in which the position of the center of gravity of the top object is high, in which the object on top is not fixed to the object that is underneath it, and the like.

For example, in a case in which a flower vase is placed on the edge of a table, the insurance contents determining unit 413 determines that a combination of factors exists, specifically that the vase could easily fall, and that the possibility of an object that has been placed on the edge of a high location falling is high if the robot 200 collides with the desk, and raises the insurance cost.

In contrast, in a case in which the same vase is placed in the center of the same desk, the insurance contents determining unit 413 determines that although it would be easy for the flower vase to fall if the robot 200 collides with the desk, it is placed in the center of a high location and therefore, the possibility of the flower vase falling over is low, and lowers the insurance cost in comparison to the previous case.

In addition, the target may also be a person instead of an object. In this case, the work information may also be information relating to the congestion of people in the work environment 1100. It is thereby possible to determine insurance contents that have a wider range of compensation and a higher compensation limit than for a case in which the insurance contents are for objects. The insurance contents determining unit 413 determines that the risk of a collision occurring between the robot 200 and a person becomes higher the higher that the degree of congestion of people is, and raises the insurance cost in comparison to a case in which there is an equal probability of a collision occurring but with an object rather than with a person.

In the same manner, the work information may also be information relating to the position of a person in the work environment 1100. The insurance contents determining unit 413 calculates the distance between the robot 200 and a person based on information relating to the position of the person, and raises the insurance cost the shorter that this distance is.

Note that although the work information according to the present embodiment has been made information relating to objects that exist in the work environment 1100, it is not limited thereto, and may also be information relating to the work contents for the robot 200. Specifically, this is information relating to the type of work, which shows the type of work that will be executed by the robot 200, information relating to an operation type, which shows a type of operation that configures the work, a work range, which shows the region in the work environment 1100 in which the work will be executed, information relating to a scheduled time until the work will be completed, and the like.

For example, in the case of a transport robot, the work type is transport, the operation type is travelling, loading cargo, unloading cargo, and the like. It is thereby possible to determine the insurance contents more appropriately according to the work contents for the robot. If there is a case in which the robot 200 is a transport robot, and it will execute the loading of cargo in addition to traveling, the insurance contents determining unit 413 determines that the possibility of a collision occurring between the robot 200 and an object other than the object that is the target of the cargo loading is high at the time of the cargo loading work, and raises the insurance cost.

In the present embodiment, the work information acquisition unit 412 measures the space of the work environment 1100 using the camera of the information terminal 1102 that belongs to the user 1101, and has acquired the information that has been measured to serve as the work information in the work environment 1100 before the user 1101 begins the work for the robot 200. However, the present embodiment is not limited thereto, and for example, the work information relating to the work environment 1100 may also be measured and acquired by a robot for use in estimating insurance costs that has been sent from the insurance company.

Conversely, the work information acquisition unit 412 may also acquire work information relating to the work environment 1100 that has been measured on site during the execution of work by the robot 200 while it is executing the work in the work environment 1100. It is thereby possible to determine the insurance contents more appropriately based on the most recent work information relating to the work environment 1100.

In addition, the insurance contents determining unit 413 may also use work information that is based on design information relating to the work environment 1110 instead of information in which the work environment 1100 has been measured. Design information is, for example CAD (Computer Aided Design) information, BIM (Building Information Modeling), and the like. It is thereby possible to simplify the measurement operations that are performed before the user begins the work for the robot.

Note that the work information may also be information that combines measurement information for the work environment 1100 and design information relating to the work environment 1100. For example, this may be information in which the positional relationship between objects in the actual space is measured, and the model positional relationships are turned into a database.

In this manner, the work information is information that is based on measurement results for the environment in which the work will be executed, information based on design information relating to the environment in which the work will be executed, or information based on a combination of measurement results and design information for the environment in which the work will be executed. It is thereby possible to compensate for information that is insufficient at the unit of the measurement information or the design information, and to more appropriately determine the insurance contents.

The insurance contents according to the present embodiment were made an insurance type and an insurance cost. However, the insurance contents are not limited thereto, and may also include a range of compensation, a compensation limit, exclusions of liability, a deductible, and the like. The compensation range according to the present embodiment is the range in which compensation can be applied as the insurance in relation to various damages that could possibly occur due to the robot 200 executing work.

For example, this is compensation in relation to damages to the robot or an object due to the robot colliding with the object, compensation for an injury caused to a person due to the robot colliding with the person, and the like. The compensation limit according to the present embodiment is the upper limit for the amount of compensation that can be given as insurance.

The exclusions from liability according to the present embodiment are categories for which compensation cannot be given as insurance from among damages that are caused by the robot 200 executing work. For example, this is a case in which the user 1101 has intentionally damaged the robot 200, and the like. The deductible amount according to the present embodiment is the amount that the user has to cover at their own expense in relation to a fixed amount for damage that occurs due to the robot 200 executing work.

In the present embodiment, although the insurance contents determining unit 413 determined the insurance contents for damages to a surrounding object due to the robot 200 executing work, this is not limited thereto. For example, the insurance contents determining unit 413 may also determine the insurance contents in relation to damages or malfunctions to the body of the robot 200 itself. That is, the insurance contents determining unit 413 determines contents for insurance that targets damages to objects and people that exist in the environment in which the robot will perform work, and to the body of the robot itself.

In addition there are also cases in which the provider of the robot is temporarily unable to lend out the robot to other users due to damages or malfunctions concerning the body of the robot 200. In preparation for this, the insurance contents determining unit 413 may also determine insurance contents relating to an NOC (Non Operation Charge). It is thereby possible for a user to use a valuable robot without worrying.

Note that in the present embodiment, the insurance contents determining unit 413 calculated the probability of a risk factor occurring based on a calculation formula relating to risk factors for each accident based on the insurance contents determining table, and determined the insurance contents according to this calculation. However, the present invention is not limited thereto, and it is sufficient if a method is used that is able to determine the insurance contents according to robot attribute information and work information.

For example, the insurance contents determining unit 413 does not need to calculate the probability of a risk factor occurring. That is, the insurance contents determining unit 413 may also use an insurance contents determining table in which each insurance cost is set based on each item such as the presence or absence of safety performance in the robot, the presence or absence of objects that exist in the work environment 1100, the material of the objects, the robot attribute information, or the work information.

In addition, the insurance contents determining unit 413 may also use this insurance contents determining table to determine the insurance contents such that it adds up all of the insurance costs for the relevant items. It is thereby possible to quickly execute the processing for the insurance contents determining unit 413.

In addition, in the present embodiment, the insurance contents determining unit 413 calculated the distribution of objects in the work environment 1100, and calculated the risk of a collision occurring between the robot 200 and each object based on the distance between the robot 200 and an object between a pair of closest objects. However, the present invention is not limited thereto, and it is sufficient if a method is used that is able to calculate the probability of a collision occurring between the robot 200 and each object in the work environment 200.

For example, the insurance contents determining unit 413 may also calculate this based on a ratio of space taken up by objects in the work region of the robot 200 in the work environment 1100. For example, the insurance contents determining unit 413 determines that that the probability of a collision occurring between the robot 200 and an object is higher the larger that the ratio of the space taken up by the object in the work region of the robot 200 becomes, and raises the insurance cost.

In addition, the insurance contents determining unit 413 may also calculate the probability of a collision occurring based on the number of objects that exist in the work environment 1100. That is, the insurance contents determining unit 413 will determine that the risk of a collision occurring between the robot 200 and an object is higher the larger the number of objects that exist in the work environment 1100 becomes, and will raise the insurance cost accordingly.

In addition, the robot attribute information acquisition unit 411 may also acquire travel path information for the robot 200 in the work environment 1100 to serve as robot attribute information. In addition, the insurance contents determining unit 413 may also calculate the probability of a collision occurring between the robot 200 and an object in relation to objects that exist on a path that the robot 200 will travel along based on the travel path information for the robot 200. It is thereby possible to efficiently execute the processing for the insurance contents determining unit 413.

In addition, although in the present embodiment, the insurance contents determining unit 413 determined the insurance contents based on the work information that was measured by the user before beginning the work for the robot 200, the present invention is not limited thereto. For example, the work information acquisition unit 412 may also successively acquire work information that was been measured on the spot by the robot 200 during the execution of the work by the robot 200, and the insurance contents determining unit 413 may also successively determine insurance contents based on this. It is thereby possible to determine the insurance contents based on the most recent state of the work environment 1100.

In addition, the insurance contents determining unit 413 may also determine the insurance contents according to the newness of work information relating to a robot work time in relation to the work information relating to the work environment 1100. Specifically, the insurance contents determining unit 413 will determine the insurance cost such that it becomes higher the older the work information is in comparison to the robot work time, because there is a high possibility that the state of the work environment 1100 has changed.

That is, the insurance contents determining unit 413 determines the insurance contents such that the insurance cost for the insurance becomes lower the more recent (newer) the time at which the work information was acquired by the work information acquisition means becomes. It is thereby possible to determine the insurance contents according to the risks due caused by a difference in the environment between the time of a previous estimate and the current work time.

In addition, in a case in which a portion of the space was not measured, and in a case in which a portion of the region could not be measured due to it being hidden by an object, when the work environment 1100 was measured by the user using the information terminal 1102 before starting the work for the robot 200, there is a possibility that the work information will be insufficient.

In this case, the insurance contents determining unit 413 may also determine the insurance contents according to an amount of work information corresponding to the work environment 1100, and a cover range (degree of sufficiency). Specifically, in a case in which the insurance contents determining unit 413 has determined that the work information does not sufficiently cover the work environment 1100, it is made such that the probability of a risk factor occurring cannot be calculated in regions for which measurement cannot be performed, and a higher insurance cost is determined.

Conversely, the insurance contents determining unit 413 may also determine the insurance cost such that the insurance cost for the insurance becomes lower the more detailed that the work information that has been acquired by the work information acquisition unit becomes. It is thereby possible to determine the insurance contents in such a way that makes up for insufficiencies in the work information.

Alternatively, the insurance contents determining unit 413 may also make it such that the work information is insufficient, and request that the user re-measure the work environment 1100. That is, it may be made such that in a case in which the work information is insufficient in order to determine the contents of the insurance, the addition of work information is proposed. Conversely, it may also be made such that it is determined that insurance cannot be granted in such a case.

In the present embodiment, the insurance contents determining unit 413 determined the insurance contents according to the risk of collision between the robot 200 and objects that exist in the work environment 1100. However, the present invention is not limited thereto, and it is sufficient if the insurance contents correspond to risks that occur due to the work that is executed by the robot 200 in the work environment 1100.

For example, this may also be the risk of damage to an object that could occur due to the work contents of the robot 200. Specifically, if the robot 200 is a cleaning robot, this is discoloring a carpet due to a cleaning agent, operation malfunctions occurring in surrounding delicate equipment due to being exposed to water when the robot 200 is executing a function in which it wipes down a surface using water, and the like. In addition, if the robot 200 is a place-setting robot, this is dishes being dropped and breaking during the execution of the place setting functions, plates falling down due to the robot 200 hitting the table, and the like.

In cases such as these, the work information acquisition unit 412 acquires information relating to the work contents as the work information. In a case in which the robot 200 is a cleaning robot that performs cleaning using a cleaning agent, the insurance contents determining unit 413 determines that the risk of the cleaning agent adhering to the carpet is high, and raises the insurance cost.

In addition, the contents may also be insurance contents corresponding to risks of causing damage to the body of the robot, as well as an object and a person that exist in the work environment 1100 due to the robot 200 falling over. In this case, the work information acquisition unit 412 acquires information relating to the state of the region of the work environment 1100 to serve as work information.

Specifically, as the state of a path surface there is information relating to the presence or absence of changes in height, how slippery the path surface is, a state of bumps on the path surface, and the like. In addition, there is also information relating to an amount of rain, and a strength of wind as the weather. If there is a case in which there are differences in height on the road surface, the road surface is slippery (there is a small friction coefficient), and there are many bumps on the road surface, then the insurance contents determining unit 413 determines that the probability of the robot falling over is high, and raises the insurance cost.

In addition, the contents may also be insurance contents corresponding to a risk of damage to the robot 200. In this case, the work information acquisition unit 412 acquires information relating to the work environment 110 to serve as work information. If there is a case in which there is a large amount of sand on the path surface, the path surface is wet, and the like, the insurance contents determining unit 413 will determine that the risk of damage occurring to the robot 200 due to sand getting stuck on the robot 200 or the robot 200 becoming wet is high, and will raise the insurance cost.

In addition, information relating to the work contents of the robot 200 may also be added as the work information. Specifically, there is information relating to garbage on the floor, information relating to a state of the floor, and information that the work contents for the robot has the work type of cleaning and the operation type of garbage collection as the information relating to the work environment 1100.

If there is a case in which there is garbage littered across the floor, or the floor is wet, the insurance contents determining unit 413 will determine that the possibility of damage occurring to the garbage intake unit due to the garbage collection work of the robot is high, and will raise the insurance cost.

In addition, the contents may also be insurance contents according to the risk of collision between robots occurring due to a plurality of robots executing work at the same time in the work environment 1100. In this case, the work information acquisition unit 412 acquires information relating to the number of robots, and the work region and travel path for each robot as the work information.

If there is a case in which a plurality of robots are executing work in the same work region at the same time, or if there is a case in which a plurality of robots will travel on the same travel path at the same time, the insurance contents determining unit 413 determines that there is a high risk of collision between the robots, and raises the insurance cost.

Although in the present embodiment, the insurance contents determining unit 413 determined the insurance contents based on work information and robot attribute information, the present invention is not limited thereto. Specifically, the insurance contents determining unit 413 may also determine the insurance contents based on just the work information.

For example, the present invention can also be used in order to give a provisional estimate of the insurance cost before a user decides which robot to use when they are reserving a robot. In this case, the insurance contents determining unit 413 compares this to a case in which the robot attribute information is used, and raises the insurance costs. At this time, the insurance contents determining unit 413 functions as an insurance contents determining means that is configured to determine the contents of insurance based on work information.

Conversely, the insurance contents determining unit 413 may also determine the insurance contents based on just the robot attribute information. For example, the present invention may also be used in a case in which at the time of reserving a robot, the user does not want to measure the work environment 1100. In this case, the insurance contents determining unit 413 compares this to a case in which the work information is used, and raises the insurance cost accordingly. At this time, the insurance contents determining unit 413 functions as an insurance contents determining means that is configured to determine insurance contents based on robot attribute information.

Furthermore, although an example of a robot has been given in the present embodiment, the present invention is not limited to use for a robot. That is, the present invention may also be applied to an information processing apparatus and an information processing method that are configured to determine the contents of insurance that targets damages that could possibly occur during work that is performed by a user operation.

In addition, it is sufficient if work information comprising information relating to at last one of an environment in which a work is executed and the contents of the work are acquired by a work information acquisition means (work information acquisition step), and the insurance contents are determined by an insurance contents determining means (insurance contents determining step) based on the work information.

As was explained above, according to the method of the First Embodiment, the information processing apparatus 110 is able to determine insurance contents based on information relating to a state of the work environment 1100 of the user, and information relating to the body of the robot, and to appropriately provide insurance to the user.

### Second Embodiment

In the Second Embodiment, an example will be explained of a technique for requesting that the user improve or assist a target for which it has been determined that there is a high risk of an accident due to the measurements of the work environment, and updating the contents of the insurance according to this.

Specifically, in a case in which it has been discovered that an object exists for which the risk of damage due to the robot executing the work is high based on the work information that has been acquired by measuring the work environment, the user is notified of the presence of this object, and the user is given the proposal that if this object is put away, the insurance cost will be reduced. It is thereby possible to provide more reasonable insurance to the user.

That is, the insurance contents determining unit 413 proposes that the user removes risk factors for damage that could possibly occur during the execution of the work by the robot based on the work information and the robot attribute information, and in a case in which the risk factor for the damage is removed, updates the insurance contents.

FIG. 9 is a functional block diagram showing a configurational example of an information system that is provided with an information processing apparatus according to the Second Embodiment. Explanations of functional blocks that are the same as the functional blocks in FIG. 4 will be omitted, and only functional blocks that are different from the functional blocks in the First Embodiment will be explained.

The information processing apparatus 110 has the robot attribute information acquisition unit 411, the work information acquisition unit 412, the insurance contents determining unit 413, and an input unit 914. The input unit 914, which serves as an input means, receives inputs of the user 1101 from the information terminal 1102 via the communications device 101.

The insurance contents determining unit 413 transmits the update proposal for the insurance contents that has been determined to the information terminal 1102 via the communications device 101, the input of the user 1101 is received on the input unit 914, and the insurance contents are updated according to this input

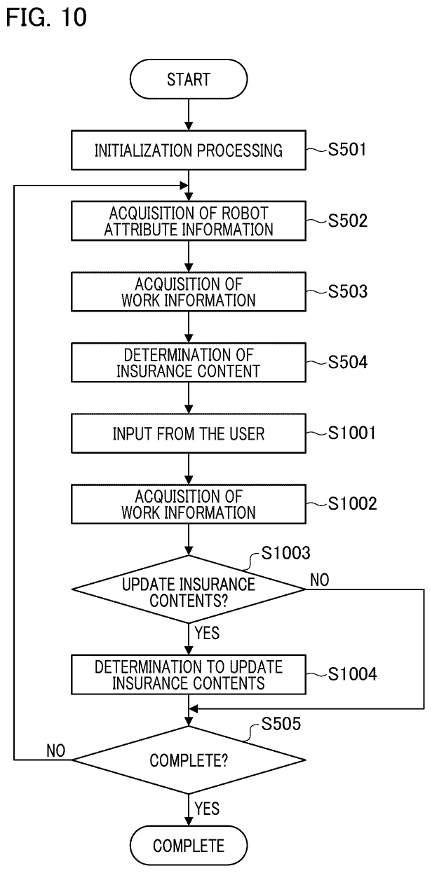

FIG. 10 is a flowchart showing an example of a processing procedure for an information processing method that uses the information processing apparatus according to the Second Embodiment. Note that the operations for each step of the flowchart in FIG. 10 are performed in order by the CPU 31 that serves as a computer inside of the information processing apparatus executing a computer program that has been stored on a memory. Note that explanations of steps that are the same as the steps in FIG. 5 will be omitted, and explanations will be given only of the steps that are different from the steps in the First Embodiment. Note that in the same manner as FIG. 5, the processing in FIG. 10 is executed repeatedly.

During step S504, the CPU 31 uses the insurance contents determining unit 413 to determine the insurance contents for the work of the robot 200 in the work environment 1100 based on the robot attribute information and the work information that have been acquired.

In the Second Embodiment, the insurance contents determining unit 413 determines that an object exists for which there is a high risk of damage due to the execution of the work by the robot 200 based on the work information relating to the work environment 1100, and determines that a reduction in the insurance costs if the same object is put away should be proposed to the user. In addition, the insurance contents determining unit 413 transmits the update proposal for the insurance contents that has been determined to the information terminal 1102 via the communications device 101.

During step S1001, the CPU 31 receives the input of the user via the communications device 101 using the input unit 914. During step 1002, the CPU 31 re-acquires the work information from the robot 200 or the information terminal 1102 via the communications device 101 by using the work information acquisition unit 412.

During step S1003, the CPU 31 uses the insurance contents determining unit 413 to determine whether or not to update the insurance contents. Specifically, in a case in which the user has accepted the proposal, and it has been determined that the same object does not exist in the new work information that has been acquired by the work information acquisition unit 412 (the user has put the object away), the processing proceeds to step S1004, and the CPU 31 uses the insurance contents determining unit 413 to update the insurance contents.

In contrast, in a case in which the user has not agreed to the proposal, or the user has agreed to the proposal, but the same object still exists in the new work information that has been acquired by the work information acquisition unit 412 (the user has not put away the object), the processing proceeds to step S505.

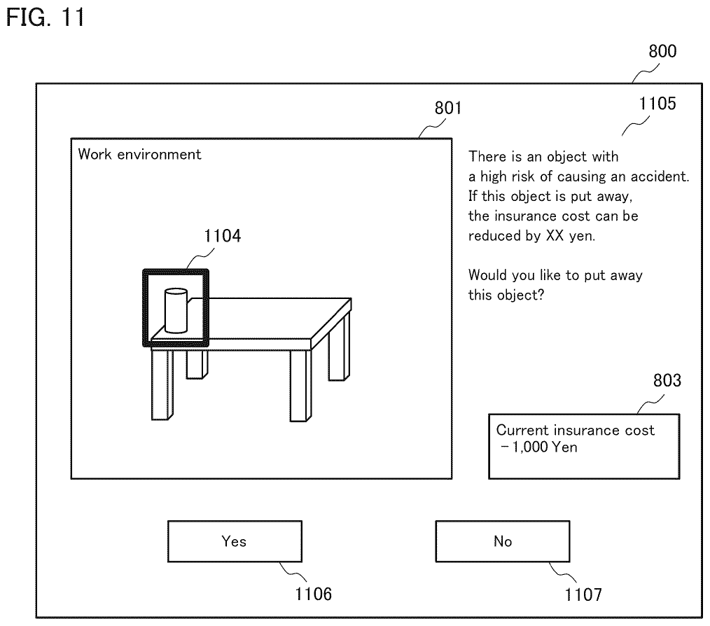

FIG. 11 is a diagram showing an example of a display screen according to the Second Embodiment, and is an example of a screen that is displayed on the information terminal 1102 of the user. Note that explanations have been omitted for the elements that are the same as the elements in FIG. 8, and only the elements that are different than the elements in the First Embodiment are explained.

The reference numeral 803 shows the current insurance contents. In a case in which the user has approved the update to the insurance contents, the post update insurance contents are shown. The reference numeral 1104 shows a region in which an object exists for which the insurance contents determining unit 413 has determined that there is a high risk of damage occurring due to the execution of the work by the robot 200.

A reference numeral 1105 is a message that shows an update proposal for the insurance contents that has been determined by the insurance contents determining unit 413. Specifically, the risk of damage to the object that is shown by the reference numeral 1104 is high, and therefore, the reference numeral 1105 shows that the insurance cost will be reduced if the object that is shown by the reference numeral 1104 is put away. A reference numeral 1106 is a button for approving the updates to the insurance contents that are shown by the reference numeral 1005. A reference numeral 1107 is a button for rejecting the updates to the insurance contents that are shown by 1105.

According to the method of the present embodiment, the information processing apparatus 110 is able to notify the user of the presence of objects for which there is a high risk of damage that exist in the work environment 1100, and to propose to the user that the insurance cost can be reduced if this object is put away. It is thereby possible to provide more reasonable insurance to the user.

In the present embodiment, the insurance contents determining unit 413 notified the user of the existence of objects for which there is a high risk of damage that exist in the work environment 1100, and proposed to the user that the insurance cost can be reduced if this object is put away. However, the present invention is not limited thereto. For example, the insurance contents determining unit 413 may also display and propose an update to insurance contents in which the insurance cost has been enhanced due to the presence of an object for which the risk of damage is high.

Note that in the present embodiment, insurance contents in which the compensation has been enhanced correspond to at least one of the compensation range being wide, the compensation limit being high, the exclusion of liability being small, the deductible amount being small, and the amount that the user must pay out of pocket being small, and insurance contents in which the compensation has been enhanced increase the insurance cost.

Note that in a case in which the work information that has been measured before the start of the work for the robot, and the work information that is measured during the work execution by the robot are compared, and the risk of an accident occurring in the work environment 1110 has been reduced, the insurance contents determining unit 413 may also propose an update to cheaper insurance contents to the user. It is thereby possible to provide insurance according to the needs of the user.

In addition, in a case in which the distance between the robot 200 and an object is closer than a predetermined distance, the insurance contents determining unit 413 may also display that there is a location in which the risk of a collision is high. It is thereby possible to display to the user 1101 that a location exists for which the risk of an accident is high when the robot 200 executes the work, and this makes it possible to draw the attention of the user 1101 to this.

In the present embodiment, the insurance contents determining unit 413 notifies the user of the existence of an object for which the risk of damage is high that exists in the work environment 1100, and displays and proposes to the user that the insurance cost can be reduced if this object is put away. However, the present invention is not limited thereto, and the present invention may also just propose the removal of an accident risk factor.

For example, in a case in which the work information acquisition unit 412 acquires information relating to a state of a path surface in the work environment 1100, if the path surface is wet, the insurance contents determining unit 413 may also display the position of the path surface that is wet, and display and propose that the path surface be wiped off because there is a risk of the robot falling over.

In addition, in a case in which there is a risk of surrounding fine equipment becoming wet and an operative malfunction being caused thereto due to the cleaning robot wiping down a surface using water, the work information acquisition unit 412 acquires the work contents for the robot and an information type for which it is possible to determine whether or not an object is fine equipment as the work information. If there is a case in which fine equipment exists close to the work region for the robot, the insurance contents determining unit 413 will propose that the fine equipment be put away.

As has been explained above, according to the method of the Second Embodiment, it is possible for the information processing apparatus 110 to notify the user of the existence of objects that exist in the work environment 1100 and have a high risk of damage and to propose that the insurance cost could be lowered by putting these objects away. Therefore, it is possible to provide the user with more reasonable insurance.

### Third Embodiment

In the Third Embodiment an example will be explained of a method in which a plurality of insurance contents are displayed and proposed to the user, and the control contents for the robot are determined according to the insurance contents (insurance plan) that the user has selected. Specifically, an expensive insurance plan with a high insurance cost that has enhanced compensation, a low-cost insurance plan with a low insurance fee for which the compensation is limited, and an insurance plan that is in between these two are determined and proposed to the user based on the work information that has been acquired by measuring the work environment.

In addition, in a case in which the user has selected the insurance plan with the high insurance cost, the robot is controlled so as to prioritize the work, and in a case in which the user has selected the insurance plan with the low cost insurance fee, the robot is controlled so as to prioritize safety. In addition, in a case in which the user has selected the insurance plan that is in between these two, the robot is controlled so as to balance both the work and the safety at a predetermined level for each. It is thereby possible to provide the user with highly convenient insurance that is linked to the operation of the robot.

FIG. 12 is a functional block diagram showing a configurational example of an information system that is provided with the information processing apparatus according to the Third Embodiment. Explanations of functional blocks that are the same as functional blocks in FIG. 9 will be omitted, and only the functional blocks that are different from the functional blocks in the Second Embodiment will be explained.

The information processing apparatus 110 has the robot attribute information acquisition unit 411, the work information acquisition unit 412, the insurance contents determining unit 413, the input unit 914, and a robot control contents determining unit 1201. The robot control contents determining unit 1201 functions as a robot control contents determining means configured to determine the control contents for the robot 200 according to the insurance contents that have been determined by the insurance contents determining unit 413, and to transmit the control contents that have been determined to the robot 200 via the communications device 101.

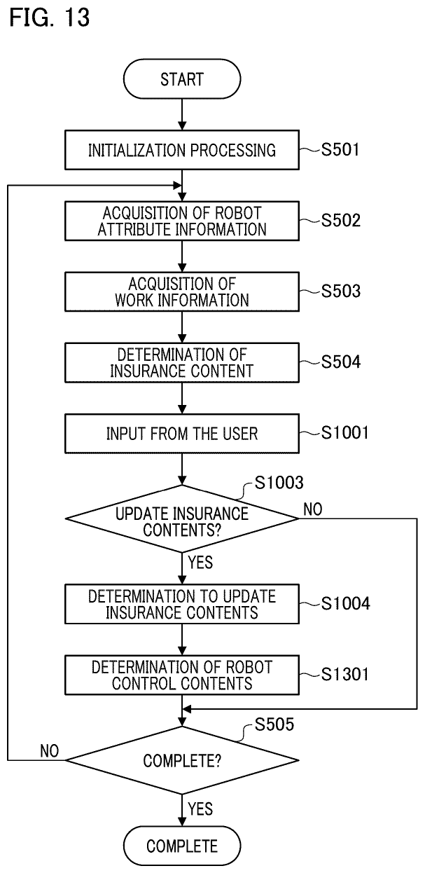

FIG. 13 is a flowchart showing an example of processing procedures for an information processing method that uses the information processing apparatus according to the Third Embodiment. Note that the operations for each step of the flowchart in FIG. 13 are performed in order by the CPU 31 that serves as a computer inside of the information processing apparatus executing a computer program that has been stored on the memory. Explanations of the steps that are the same as the steps in FIG. 10 will be omitted, and explanations will only be given of the steps that are different than the steps in the Second Embodiment. Note that the processing for FIG. 13 is executed repeatedly, in the same manner as for FIG. 10.

During step S504, the CPU 31 uses the insurance contents determining unit 413 to determine the insurance contents for the work of the robot 200 in the work environment 1100 based on the robot attribute information and the work information that have been acquired.

In addition, the insurance contents determining unit 413 determines insurance contents for which the range of compensation has been made wider and the insurance fee has been made more expensive (an enhanced compensation plan) and insurance contents in which the compensation range has been made more narrow and the insurance fee has been made less expensive (a limited compensation plan) in relation to the insurance contents that have been determined (an intermediate plan). In addition, the insurance contents determining unit 413 displays and proposes the plurality of insurance plans that have been determined to the user, and transmits this to the information terminal 1102 via the communications device 101 such that the user 1101 will select one of the plurality of insurance plans that have been determined.

During step S1001, the CPU 31 uses the input unit 914 to receive inputs from the user 1101 via the communications device 101. In the present embodiment, the input unit 914 receives the insurance contents that have been selected by the user 1101 in relation to the plurality of insurance contents that were proposed by the insurance contents determining unit 413.

During step S1003, the CPU 31 determines whether or not to update the insurance contents that were previously determined according to the insurance contents that have been selected by the user 1101 using the insurance contents determining unit 413. In a case in which it has been determined that the insurance contents will be updated, the processing proceeds to step S1004. In contrast, in a case in which it has been determined that the insurance contents will not be updated, the processing proceeds to step S505.

During step S1004, the CPU 31 uses the insurance contents determining unit 413 to determine that the insurance contents should be updated to the insurance contents that have been selected by the user 1101. During step S1301, the CPU 31 uses the robot control contents determining unit 1201 to determine the control contents for the robot 200 based on the insurance contents that have been determined by the insurance contents determining unit 413.

That is, the insurance contents determining unit 413 determines the insurance contents for one or more insurance plans that have different insurance contents, and based on the input that has been received by the input unit 914, determines the contents of the insurance that have been selected from among the insurance contents of the at least one or more insurance plans.

In the present embodiment, in a case in which the insurance contents determining unit 413 has determined the insurance contents in which the compensation range has been made wider (the enhanced compensation plan), the robot control contents determining unit 1201 determines that the robot 200 will be proactively operated so as to prioritize the completion of the work. Specifically, the robot control contents determining unit 1201 will raise both the travel speed and the operation speed of the robot 200 to each be higher than a predetermined speed.

In contrast, in a case in which the insurance contents determining unit 413 has determined the insurance contents in which the compensation range has been made more narrow (the limited compensation plan), the robot control contents determining unit 1201 determines that the robot 200 will be operated so as to prioritize safety.

Specifically, the robot control contents determining unit 1201 will lower both the travel speed and the operation speed of the robot 200 so as to each be lower than a predetermined speed. In addition, the robot control contents determining unit 1201 will then transmit the control contents that have been determined to the robot 200 via the communications device 101. In this manner, in a case in which the compensation range is wide and the compensation amount is high for the insurance contents, the robot will be operated so as to prioritize the work, and in a case in which the compensation range is narrow and the compensation amount is low for the insurance contents, the robot will be operated so as to prioritize safety.

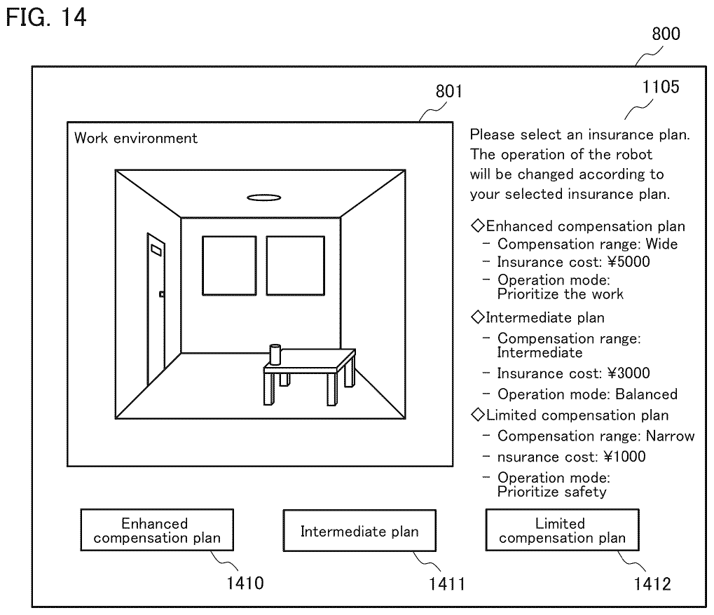

FIG. 14 is a diagram showing an example of a display screen according to the Third Embodiment. Note that explanations of the elements that are the same as the elements in FIG. 11 will be omitted, and only the elements that are different than the elements in the Second Embodiment will be explained.

The reference numeral 1105 is a message showing a proposal of a plurality of insurance contents that have been determined by the insurance contents determining unit 413. Specifically, this shows the enhanced compensation plan, which is the insurance contents in which the compensation range is wide and the insurance cost is high, the limited compensation plan, which is the insurance contents in which the compensation range is narrow and the insurance cost is low, and the intermediate plan, which is the insurance contents that are in between the insurance plan A and the insurance plan C.

A reference numeral 1410 is a button for selecting the enhanced compensation plan. A reference numeral 1411 is a button for selecting the intermediate plan. A reference numeral 1412 is a button for selecting the limited compensation plan.

According to the method of the present embodiment, it is possible for the information processing apparatus 110 to determine the control contents for the robot according to the insurance contents that have been determined, and to provide highly useful insurance that is linked to work of the robot.

In the present embodiment, the robot control contents determining unit 1201 determined the operation speed of the robot 200 according to the insurance contents. However, the present invention is not limited thereto, and it is sufficient if the completion of the work that the robot 200 will execute is prioritized in relation to insurance contents having a wide compensation range, and the safety of the robot 200 is prioritized in relation to insurance contents having a narrow compensation range.

For example, the robot control contents determining unit 1201 may loosen the safety margins for the detection of obstacles to the robot 200 in relation to insurance contents having a wide range of compensation (make the distance between the robot and an object at which braking or avoiding the object is performed at the time of obstacle detection shorter than a predetermined distance). In addition, the robot control contents determining unit 1201 will determine that the spatial analysis function or the time analysis function (frequency) will also be made shorter than a predetermined value.

In contrast, the robot control contents determining unit 1201 will make the safety margins for obstacle detection stricter (make the distance between the robot and an object at which braking or avoiding the object is performed at the time of obstacle detection longer than a predetermined distance) in relation to insurance contents having a narrow range of compensation. In addition, the robot control contents determining unit 1201 will determine that the spatial analysis function and the time analysis function (frequency) will also be made higher than a predetermined value. It is thereby possible to appropriately control the robot according to the insurance contents that have been determined, and it is possible to increase the convenience for the user.

In addition, in a case in which during the executing of a work by the robot 200, it has been discovered that a plurality of objects for which there is a high risk of damage exist by measuring the work environment 1100 of the robot 200, the insurance contents determining unit 413 will propose an update to the insurance contents to insurance contents with a wider range of compensation and a higher insurance cost to the user 110. In this case, the robot control contents determining unit 1201 may also perform control so as to temporarily halt the work of the robot 200 until the user 1101 has approved the new insurance contents.

It is thereby possible to temporarily suppress the risk of damage due to the robot 200 executing work. In addition, in a case in which the user 1101 has approved the new insurance contents, and the insurance contents determining unit 413 has determined that the insurance contents will be updated to the new insurance contents, the robot control contents determining unit 1201 determines that the robot 200 should restart the execution of the work.

As has been explained above, according to the method of the Third Embodiment, the information processing apparatus 110 is able to determine the control contents for the robot according to the insurance contents that have been determined, and is able to provide highly convenient insurance that is linked with the work that the robot will execute.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, and the like) of the information processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-011711, filed on Jan. 30, 2024, which is hereby incorporated by reference herein in its entirety.

What is claimed is:

1. An information processing apparatus configured to determine insurance contents that target damage that could possibly occur during work that is executed by a robot, the information processing apparatus comprising:
one or more memories storing instructions; and
one or more processors executing the instructions to:
acquire robot attribute information relating to the robot;
acquire work information including information relating to at least one of an environment in which the work will be executed, and work contents for the robot; and
determine the insurance contents based on at least one of the work information and the robot attribute information.

2. The information processing apparatus according to claim 1, wherein a degree of damage that represents the size of the damage that could possibly occur during the execution of the work by the robot is calculated based on the work information and the robot attribute information, and the insurance contents are determined such that the higher the calculated degree of damage is, the higher an insurance cost for the insurance becomes.

3. The information processing apparatus according to claim 1, wherein a probability of occurrence for the damage that could possibly occur during the execution of the work by the robot is calculated based on the work information and the robot attribute information, and the insurance contents are determined such that the higher the calculated probability of occurrence is, the higher an insurance cost for the insurance becomes.

4. The information processing apparatus according to claim 1, wherein the work information is information based on measurement results for the environment in which the work will be executed, information based on design information related to the environment in which the work will be executed, and information based on a combination of the information based on measurement results for the environment in which the work will be executed and the information based on design information related to the environment in which the work will be executed.

5. The information processing apparatus according to claim 1, wherein the insurance contents are determined with an object or a person that exists in the environment in which the work will be executed by the robot as a target of the damage that could possibly occur, or with the body of the robot as the target of the damage that could possibly occur.

6. The information processing apparatus according to claim 1, wherein the insurance contents are updated in a case in which a proposal is made to a user so as to remove a cause for the damage that could possibly occur during the execution of the work by the robot based on the work information or the robot attribute information, and the cause of the damage has been removed.

7. The information processing apparatus according to claim 1, wherein at least one or more insurance contents for which the contents of the insurance are different are determined, and the insurance contents that have been selected from among the at least one or more insurance contents are determined based on an input that has been received.

8. The information processing apparatus according to claim 7, wherein control contents for the robot are determined according to the determined insurance contents.

9. The information processing apparatus according to claim 8, wherein the control contents for the robot are determined such that in a case in which a compensation range for the insurance contents is wide, and a compensation amount for the insurance contents is high, the robot will be operated so as to prioritize the work that the robot will execute, and in a case in which the range of compensation for the insurance contents is narrow, and the compensation amount for the insurance contents is low, the robot will be operated so as to prioritize safety of the robot.

10. The information processing apparatus according to claim 1, wherein the insurance contents are determined such that the more recent a time at which the work information has been acquired is, the lower an insurance cost for the insurance becomes.

11. The information processing apparatus according to claim 1, wherein the insurance contents are determined such that the more detailed the acquired work information is, the cheaper an insurance cost for the insurance becomes.

12. The information processing apparatus according to claim 1, wherein in a case in which the work information for determining the insurance contents is insufficient, the addition of work information is proposed.

13. An information processing apparatus configured to determine insurance contents that target damage that could possibly occur during work that is executed by a robot, the information processing apparatus comprising;
one or more memories storing instructions; and
one or more processors executing the instructions to:
acquire work information including information relating to at least one of an environment in which the work will be executed, and work contents for the robot; and
determine the insurance contents based on the work information.

14. An information processing apparatus configured to determine insurance contents that target damage that could possibly occur during work that is executed by a robot, the information processing apparatus comprising;
one or more memories storing instructions; and
one or more processors executing the instructions to:
acquire robot attribute information relating to the robot; and
determine the insurance contents based on the robot attribute information.

15. An information processing apparatus configured to determine insurance contents that target damage that could possibly occur during work, the information processing apparatus comprising;
one or more memories storing instructions; and
one or more processors executing the instructions to:
acquire work information including information relating to at least one of an environment in which the work will be executed, and work contents; and
determine the insurance contents based on the work information.

16. An information processing method configured to determine insurance contents that target damage that could possibly occur during work that is executed by a robot, the method comprising:
acquiring robot attribute information relating to the robot;
acquiring work information including information relating to at least one of an environment in which the work will be executed, and work contents for the robot; and
determining the insurance contents based on at least one of the work information and the robot attribute information.

17. An information processing method configured to determine insurance contents that target damage that could possibly occur during work that is executed by a robot, the method comprising:
acquiring work information including information relating to at least one of an environment in which the work will be executed, and work contents for the robot; and
determining the insurance contents based on the work information.

18. An information processing method configured to determine insurance contents that target damage that could possibly occur during work that is executed by a robot, the method comprising:
acquiring robot attribute information relating to the robot; and
determining the insurance contents based on the robot attribute information.

19. An information processing method configured to determine insurance contents that target damage that could possibly occur during execution of work, the information processing method comprising:
acquiring work information including information relating to at least one of an environment in which the work will be executed, and work contents; and
determining the insurance contents based on the work information.

20. A non-transitory computer-readable storage medium configured to store a computer program comprising instructions for executing the following processes:
in order to determine insurance contents that target damage that could possibly occur during work that is executed by a robot:
acquiring robot attribute information relating to the robot
acquiring work information including information relating to at least one of an environment in which the work will be executed, and work contents for the robot; and
determining the insurance contents based on at least one of the work information and the robot attribute information.
